(19) United States
(12) Patent Application Publication
(10) Pub. No.: US 2005/0052770 A1
(43) Pub. Date: Mar. 10, 2005

(54) Method and apparatus for recovering read errors in a disk drive

(75) Inventor: Koji Osafune, Ome-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/628,486

(22) Filed: Jul. 29, 2003

(30) Foreign Application Priority Data
Aug. 28, 2002 (JP) 2002-248780

(51) Int. Cl. G11B 5/09; G11B 27/36; G11B 21/02

(52) U.S. Cl. 360/51; 360/31; 360/75

(57) ABSTRACT

Disclosed herein is a disk drive that performs a read-retry to recover a read error resulting from a frequency-fluctuating part of any data region provided on the disk medium. The disk drive has a read channel, CPU, phase-locked loop unit and PLL control circuit. The read channel reproduces data from the disk medium in synchronism with a read lock signal generated by the phase-locked loop unit. When a read error is made while the read channel is reading data from the data region of the disk medium, the CPU causes the PLL control circuit to alter the PLL parameters of the phase-locked unit, whereby a read-retry is carried out.

### CROSS-REFERENCE TO RELATED APPLICATIONS

This application is based upon and claims the benefit of priority from the prior Japanese Patent Application No. 2002-248780, filed Aug. 28, 2002, the entire contents of which are incorporated herein by reference.

### BACKGROUND OF THE INVENTION

1. Field of the Invention

The present invention relates to the field of disk drives. More particularly, the invention relates to an apparatus and method for recovering read errors made in the data-reading and -writing operation.

2. Description of the Related Art

In recent years, the data-recording density has increased in the field of disk drives, of which a hard disk drive is a representative example. To enhance the data-recording density it is demanded that various technical improvements be made. One of such technical improvements is to reduce the flying height of the head incorporated in any disk drive. The term “flying height” is the distance between the surface of a disk (recording medium) and the head (more precisely, the head element mounted on the slider).

Recently, the flying height of the head has decreased to a limit of about 10 nm. The possibility that the head contacts the disk while reading data from, or writing data on, the disk, is increasing because of changes in the environmental conditions, such as atmospheric pressure and temperature.

Disk drives of contact type have been developed to reduce the flying height beyond the limit. In a contact-type disk drive, the head remains in actual contact (or pseudo contact) with the disk while it is reading data from, or writing data on, the disk. The head needs to slide on the disk at an appropriate coefficient of friction. If the disk has an extremely smooth surface, the head may undergo so-called “stick-slip” or may stick, in the worst case, to the surface of the disk.

Hence, the disk should not have too smooth a surface. In other words, it should have a suitable roughness. To this end, the disk has tiny projections on its surface. It is most desired that the projections be identical in length and shape and be distributed in uniform density all over the disk. In practice, however, the projections differ in length, shape and distribution density, from a position to another on the surface of the disk. Consequently, the coefficient of kinetic friction differs from a position to another on the surface of the disk. The force with which the head is inevitably dragged in the spinning direction the disk minutely changes. Thus, the position that the head takes in the circumferential direction of the disk changes minutely, too. The speed at which the head moves relative to the disk inevitably changes. The changes in the relative speed of the head results in fluctuation in the frequency of the data recorded on the disk.

Experiments have shown that the fluctuation of frequency lasts for a short time of about 100 ns, or for a relatively long time of about 10 μs at the center frequency of approximately 100 kHz. It is inferred that the short-period fluctuation occurs while the projections of the disk remain in contact with the head element, and that the long-period fluctuation occurs while the head is undergoing stick-slip.

The disk drive incorporates a read channel that reproduces the data recorded on the disk. While the read channel is reading the data from the disk, a data-reproduction parameter (e.g., PW50, or pulse width at 50% threshold) may vary with the ambient temperature.

Vibration or impacts may be applied to the disk drive from outside, displacing the head, while the head is reading data from the disk. If this happens, a read error will be made and the data will not be decoded as is desired.

Most disk drives have a read-error recovering function to recover the data that has been read in an undesirable manner. Generally, this function is performed by changing the parameter of the read channel (e.g., the degree of boosting at the filter) or by changing the position of the head a little to accomplish a read-retry. A method of carrying out a read-retry is disclosed in, for example, Jpn. Pat. Appln. KOKAI Publication No. 2000-311347.

It has been confirmed that the read error cannot be recovered in the contact-type disk drive even if the read-retry is performed. It has been found that the read error cannot be recovered in some cases in the disk drive of head-flying type, either. Analysis of the read errors reveals that the errors result from the frequency jitters in the data region of the disk, which develop as the head contacts the disk (more correctly, the projections of the disk). Note that “frequency jitter” is the fluctuation in the frequency of the data recorded in the data region of the disk.

Thee publication specified above discloses a method in which the gain (parameter) of the PLL circuit incorporated in, for example, the read channel is changed to carry out a read-retry. However, this method is not designed to recover read errors that result from the fluctuation in the frequency of data recorded in the data region of a disk. Hence, it is not a method that is effective in recovering read errors.

### BRIEF SUMMARY OF THE INVENTION

In accordance with one embodiment of the present invention, there is provided a disk drive that can reliably recover the read errors made at frequency-jitter (frequency-fluctuating) parts of the data region of a disk-shaped recording medium.

More specifically, the embodiment of the invention is to provide a disk drive that has the function of performing a read-retry to recover the read errors made at the frequency-jitter parts that exist in the PLL-sync data recorded in the data region of the medium.

The drive disk comprises: a head which reads data signals from any data region provided on a disk-shaped recording medium; a phase-locked loop unit 105 which generates a read clock signal; a read channel 10 which reproduces data from any data signal that the head has read from the disk-shaped recording medium, in synchronism with the read clock signal generated by the phase-locked loop unit; and a controller 13 which alters a PLL parameter of the phase-locked unit when the data recorded by the read channel contains an error, the PLL parameter being related to a frequency-jitter part existing, due to the error, in PLL sync data recorded in the data region, and which performs a read-retry in accordance with the PLL parameter thus altered, to cause the read channel to read the data again.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the major parts of the read/write channel incorporated in an embodiment of this invention;

FIG. 2 is a block diagram of the major components of the disk drive according to the embodiment;

FIGS. 3A to 3D are a timing chart explaining the basic operation of the PLL circuit provided in the embodiment;

FIGS. 4A to 4C are a diagram illustrating why a read error is made, which the embodiment of the invention is to recover;

FIGS. 5A to 5C are a diagram illustrating why another read error is made, which the embodiment of the invention is to recover, too;

FIGS. 6A to 6C are a timing chart explaining the first read-retry method performed in the embodiment of this invention;

FIGS. 7A to 7C are a timing chart displaying the second read-retry method carried out in the embodiment of the invention;

FIGS. 8A to 8C are a timing chart explaining the third read-retry method effected out in the embodiment of the invention;

FIG. 9 is a flowchart explaining the fourth read-retry method carried out in the embodiment of the invention;

FIG. 10 shows a parameter table used in the embodiment of the present invention;

FIG. 11 is a flowchart explaining the fifth read-retry method carried out in the embodiment of the invention; and

FIG. 12 is a flowchart illustrating how a modification of the embodiment operates.

### DETAILED DESCRIPTION OF THE INVENTION

An embodiment of the present invention will be described, with reference to the accompanying drawings.

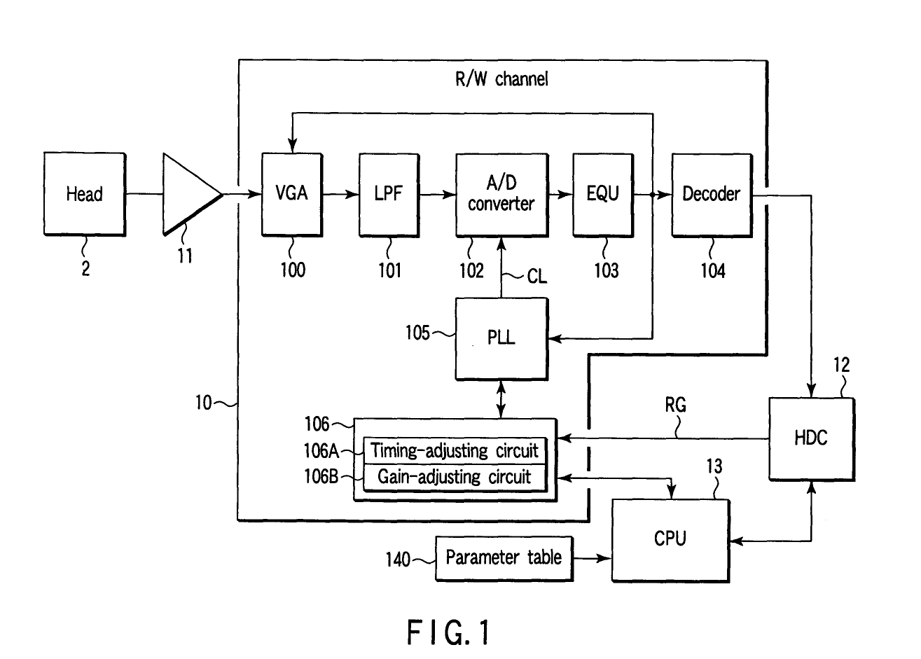

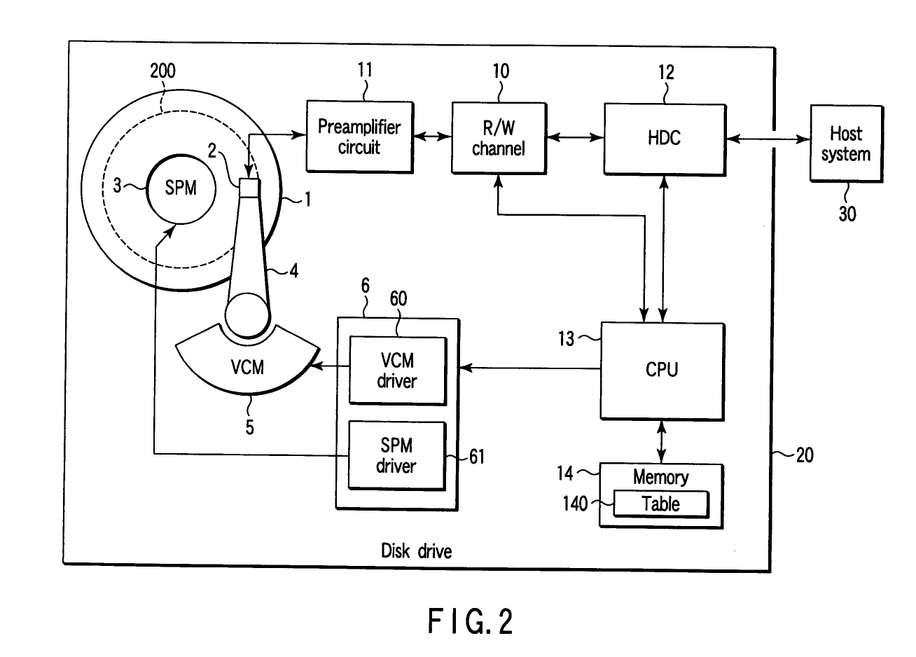

FIGS. 1 and 2 are block diagrams. FIG. 1 shows the major parts of the read/write channel incorporated in an embodiment of the invention. FIG. 2 depicts the major components of the disk drive according to the embodiment.

(Disk Drive)

As FIG. 2 shows, the disk drive 20 that is an embodiment of the invention comprises a disk-shaped recording medium 1 and a magnetic head 2 (hereinafter referred to as “disk” and “head,” respectively). The disk drive 20 further comprises a spindle motor (SPM) 3, an actuator 4, a voice coil motor (VCM) 5, and a motor driver IC 6. The disk 1 is secured to SPM 3 and can therefore be rotated at high speed. The disk 1 has a number of tracks 200, which are data-recording regions. Note that the disk drive 20 may be of the type in which the disk 1 and head 2 contact or of the ordinary type in which the heat 2 usually floating may likely contact the disk 1.

The head 2 comprises a read head element and a write head element. The read head element is designed to read data from the disk 1, and the write head element to write data on the disk 1. Both head elements are mounted on the slider of the actuator 4. When driven by the VCM 5, the actuator 4 moves the head 2 to a target position over the disk 1. The target position is the very track, from which data should be read and on which data should be written. The VCM 5 is driven by the motor driver IC 6, which is controlled by a CPU 13 provided in the disk drive 20.

The motor driver IC 6 incorporates a VCM driver 60 and an SPM driver 61. The VCM driver 60 supplies a drive current to the VCM 5. The CPU 13 controls the motor driver IC 6, which in turn controls the SPM 3 and VCM 5.

The disk 1, head 2, SPM 3, actuator 4, VCM 5 and motor drive IC 6 constitute a head/disk assembly. Besides the head/disk assembly, the disk drive 20 comprises a circuit system. The circuit system comprises a read/write (R/W) channel 10, a preamplifier circuit 11, a disk controller (HDC) 12, the above-mentioned CPU 13, and a memory 14.

The preamplifier circuit 11 has a read amplifier and a write amplifier. The read amplifier amplifies any signal that the read head element has read from the disk 1 (hereinafter referred to as “read signal”). The write amplifier converts any signal output from the R/W channel 10 to a signal representing the data to be written on the disk 1 (hereinafter referred to as “write signal”). The write signal generated by the write amplifier is supplied to the write head element.

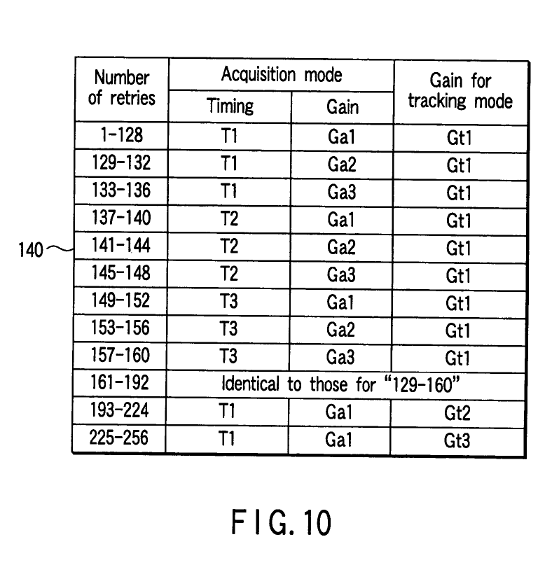

The CPU 13 is the main control device in the disk drive 20. It performs servo control to position the head 2 at a desired position. It also performs read/write control (including the control of read-retry). The memory 14 includes a RAM, a ROM and a flash memory (EEPROM) that is a nonvolatile memory. The flash memory stores a parameter table 140 that is used in the read-retry operation. (See FIG. 10, or schematic representation of the parameter table 140.)

The HDC 12 functions as host interface and is connected to a host system 30 (e.g., a personal computer or a digital device) that is provided outside the disk drive 20. The HDC 12 functions as disk interface, too: it transfers signals to, and receives signals from, the R/W channel 10.

(Read Channel)

The R/W channel 10 is a signal-processing IC that processes read signals and write signals. As in most cases, it is a PRML (Partial Response Maximum Likelihood) data channel. The R/W channel 10 incorporates a read channel. FIG. 1 shows the major components of the read channel and some elements provided in the R/W channel 10.

As shown in FIG. 1, the read channel has a variable gain amplifier (VGA) 100, a low-pass filter (LPF) 101, an A/D converter 102, a digital equalizer 103, a decoder 104, and a PLL (Phase-Looked Loop) circuit 105.

The VGA 100 is an amplitude-adjusting circuit that receives a read signal from the preamplifier circuit 11 and maintains the amplitude of the read signal at a predetermined value. The preamplifier circuit 11 amplifies any read signal the read head of the head 2 has read from the disk 1. The read signal amplified by the preamplifier circuit 11 is supplied to the R/W channel 10. The LPF 101 removes noise from the read signal output from the VGA 100.

The A/D converter 102 receives any read signal from the LPF 101, which is an analog signal, and converts the signal to a digital read signal. The equalizer 103 includes a transversal filter as in most cases. It receives the digital read signal and changes the waveform of the signal to a prescribed signal waveform. The decoder 104 is a data-decoding circuit of PRML type and reproduces the data from the read signal. The data reproduced is supplied from the decoder 104 to the HDC 12.

The PLL circuit 105 generates a read clock signal CL that the A/D converter 102 uses to convert analog read signals to digital read signals. The PLL circuit 105 includes a phase comparator, low-pass filter (LPF) and voltage-controlled oscillator (VCO). It is one type of a feedback system.

The PLL circuit 105 receives the read signal (a digital signal) output from the equalizer 103. In the PLL circuit 105, the output signal of the VCO is controlled to have a predetermined phase relation with the input read signal input (i.e., a modulated digital signal). That is, the PLL circuit 105 supplies a read clock signal CL to the A/C converter 102. The read clock signal CL has the same frequency and phase as the read signal (the modulated data recorded).

As FIG. 1 shows, the R/W channel 10 further comprises a PLL control circuit 106. The PLL control circuit 106 sets a plurality of PLL parameters in the PLL circuit 105. Among the PLL parameters are the timing and gain for the acquisition mode, which accord with a read-gate signal RG, and a gain for the tracking mode. The CPU 13 refers to the parameter table 140 stored in the memory 14 and causes the PLL control circuit 106 to set PLL parameters in the PLL circuit 105 or change the PLL parameters set in the PLL circuit 105.

The PLL control circuit 106 includes a timing-adjusting circuit 106A and a gain-adjusting circuit 106B that corporate to set and change each PLL parameter. The timing-adjusting circuit 106A adjusts the timing that the CPU 13 has set for the acquisition mode and the timing that accords with the read-gate signal RG. The gain-adjusting circuit 106B adjusts the gains that the CPU 13 has set for the acquisition mode and tracking mode, respectively. Note that the read-gate signal RG is a timing signal output from the HDC 12 and sets the timing of reproducing (reading) the data recorded on the disk 1.

The PLL control circuit 106 detects the operating conditions of the PLL circuit 105, holds the information representing the operating condition detected and supplies the information to the CPU 13. The operating conditions include a phase error or a frequency error in the acquisition mode and a phase error or a frequency error in the tracking mode.

(Data-Reading Operation and PLL Operation)

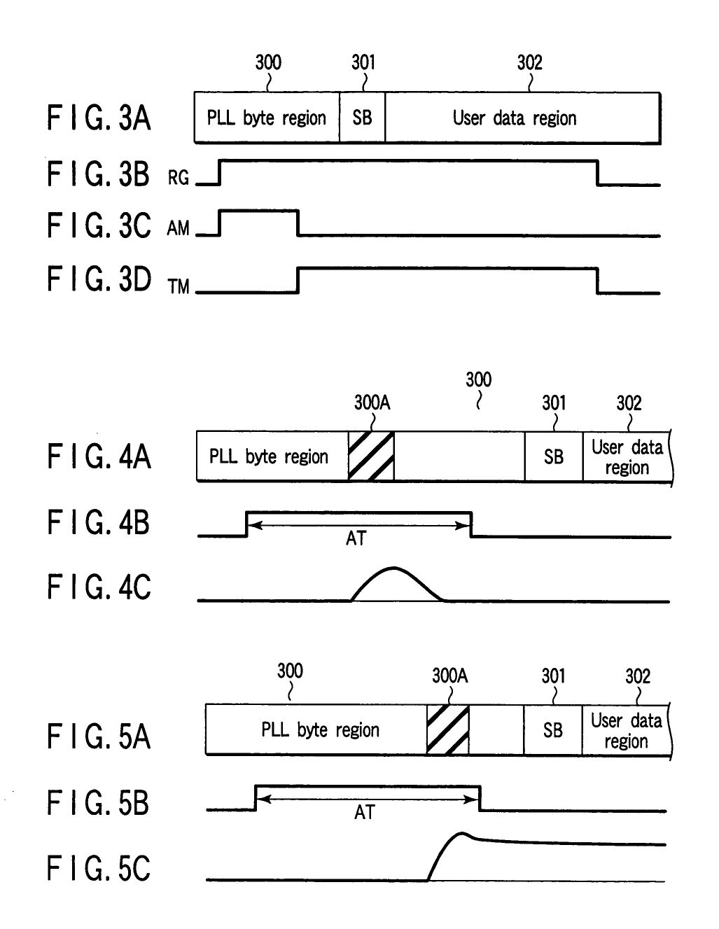

The data-reading operation performed in the disk drive 20 and the basic operation of the PLL circuit 105 will be described, with reference to FIGS. 3A to 3D, FIGS. 4A to 4C, FIGS. 5A to 5C and FIG. 9.

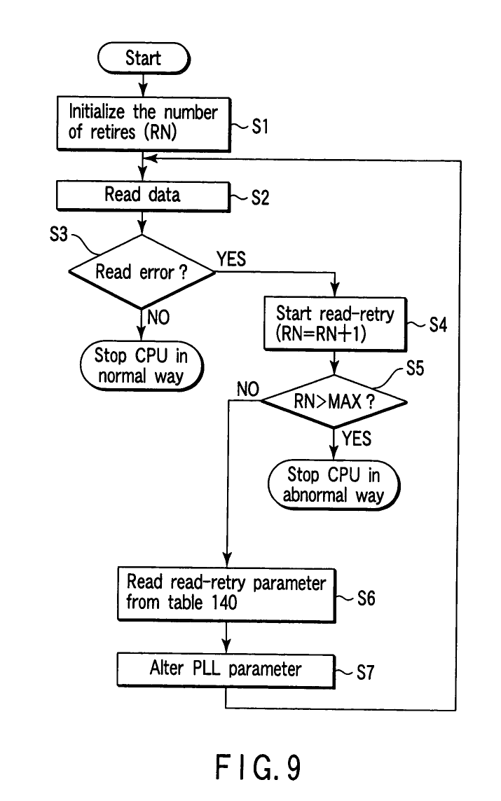

As shown in the flowchart of FIG. 9, the CPU 13 initializes the counter (not shown) that counts the number (RN) of times the read-retries performed (Step S1). Then, the CPU 13 drives the motor drive IC 6 to read data from the disk 1, in response to a read command supplied from the host system 30 (Step S2). More precisely, the VCM driver 60 provided in the motor drive IC 6 drives the VCM 5, which in turn drives the actuator 4. As a result, the head 2 moves to the target track (e.g., track 200) and then read data from the target track.

The CPU 13 controls the PLL control circuit 106, which in turn controls the PLL circuit 105. Thus controlled, the PLL circuit 105 causes the read channel to start operating. At this time, the HDC 12 supplies a read-gate signal RG to the R/W channel 10, designating the timing of starting the reading of data.

The track 200 on the disk 1 consists of a plurality of data sectors (data regions). As FIG. 3A shows, each data sector is composed of a PLL-sync data region (PLL byte region) 300, a sync byte region 301, and a user data region 302. Recorded in the PLL-sync data region 300 is sync data that has a predetermined frequency (representing, for example 2T patterns, where T is one-bit time). Recorded in the sync byte region 301 is sync data that indicates the starting point of the user data region 302. Recorded in the user data region 302 is the user data transferred from the host system 30.

The head 2 starts reading data from any data sector on the disk 1 when the read-gate signal RG becomes active in the PLL-sync data region 300. In the read channel, the PLL circuit 105 generates a read clock signal CL from the signal read from the disk 1. The read clock signal CL is supplied to the A/D converter 102 so that data may be reproduced from the read signal.

As indicated above, the PLL circuit 105 can operate in two modes, acquisition mode (AM) and tracking mode (TM). The PLL circuit 105 operates in the acquisition mode as long as the read-gate signal RG is active. In the acquisition mode, the PLL circuit 105 fast adjusts the frequency and phase of the read signal to those of the data output from the equalizer 103. In the acquisition mode, the PLL circuit 105 receives data having a prescribed frequency and read from the PLL byte region 300. This data is the read data.

While operating in the acquisition mode as shown in FIG. 3, the PLL circuit 105 can reduce the phase error and freqeuncy error in the read data to permissible values, if it has no troubles at all. Note that the phase error and the frequency error have been made in the voltage-controlled oscillator (VCO). When the acquisition mode period expires, the PLL circuit 105 starts operating in the tracking mode as illustrated in FIG. 3D. In the tracking mode, the PLL circuit 105 operates in accordance with the rotation speed of the SPM 3. Usually, its gain is decreased in order not to malfuction when influenced by noise or the like. This means that the tracking mode is a PLL-operating mode in which the frequency and phase of the read signal are slowly adjusted to those of the data output from the equalizer 103.

When the data is reproduced in normal way in the data-reading operation described above, the CPU 13 stops operating in normal manner (if NO in Step S3). The HDC 12 may detect an read error. In this case, the CPU 13 starts a read-retry to recover the read error (Step S4, if YES in Step S3).

The number of times (MAX) the read-retry can be repeated is limited to, for example, 256 times. The CPU 13 determines whether the number of times (RN) the read-retry has been repeated exceeds the number of times (MAX) (Step S5). If the read-retry is repeated more times than the value MAX (if YES in Step S5), the CPU 13 determines that the read error cannot be recovered and stops the R/W channel 10. In this case, the CPU 13 supplies a signal to the host system 30 via the HDC 12, informing the system 30 that an read error has occurred in the R/W channel 10.

(First Read-Retry Method)

Assume that the head 2 abut on the projections of the disk 1, forming a frequency-jitter part 300A in the PLL-sync data region 300, as illustrated in FIG. 4A. In the frequency-jitter part 300A, the frequency of the read signal is fluctuating for a short time.

In the data-reading operation, the PLL circuit 105 has a relatively large gain during the acquisition-mode the period (AT), as is illustrated in FIG. 4B. The gain of the PLL circuit 105 quickly changes in accordance with the read signal. If the frequency-jitter part 300A lies in the middle of the PLL-sync data region 300, the frequency of the output data of the PLL circuit 105 will probably regains the normal value before the PLL circuit 105 ceases to operate in the acquisition mode (AM). In other words, the frequency error exceeds the permissible value in only the middle part of the acquisition-mode period (AT).

The frequency-jitter part 300A may lie near the end of the acquisition-mode period (AT) as shown in FIGS. 5A and 5B. In this case, the frequency of the output data of the PLL circuit 105 exceeds the permissible value for a long time, as seen from FIG. 5C. That is, the frequency of the output data of the PLL circuit 105 cannot regain the normal value before the PLL circuit 105 ceases to operate in the acquisition mode (AM). Hence, the operating mode of the PLL circuit 105 will likely change from the acquisition mode to the tracking mode. In the tracking mode, the PLL circuit 105 has a relatively small gain and it takes much time until the output data of the circuit 105 regains the normal value. Consequently, data cannot be read in the desired manner from the sync byte region 301 or the user data region 302. This increases the possibility of making read errors.

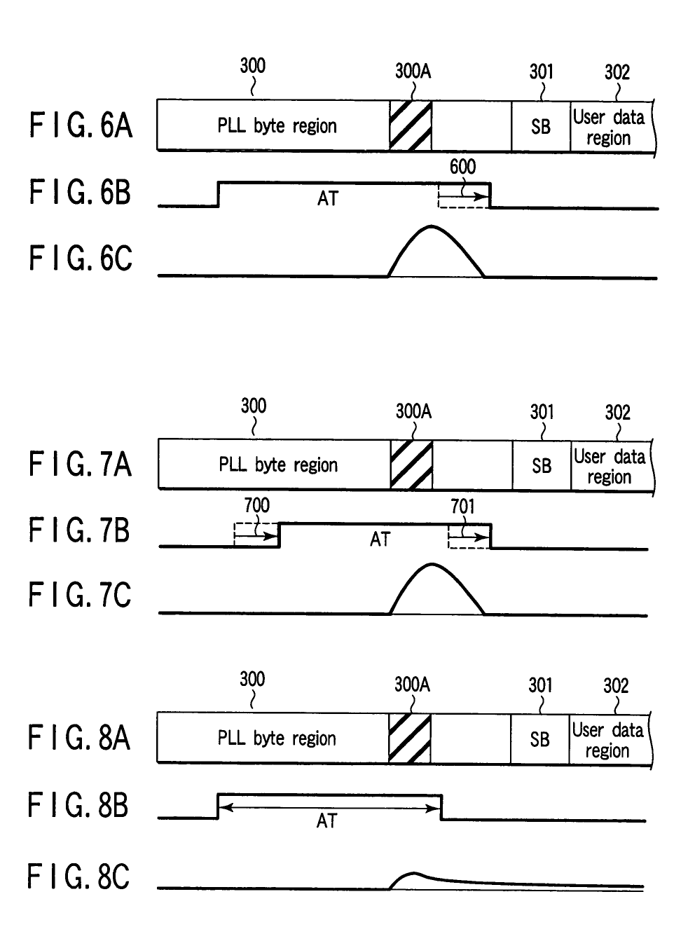

Thus, the CPU 13 changes a PLL parameter to lengthen the acquisition-mode period (AT) by time 600, as is shown in FIGS. 6A and 6B. More specifically, the CPU 13 changes the timing set by the timing-adjusting circuit 106A incorporated in the PLL control circuit 106.

The read-retry method thus performed relocates the frequency-jitter part 300A at the middle part of the acquisition-mode period (AT). This enhances the possibility that the output data of the PLL circuit 105 regains the normal value until the acquisition-mode period (AT) expires. In other words, the period during which the frequency error exceeds the permissible value in the acquisition mode (AM) becomes short as shown in FIG. 6C. Hence, the read-retry operation reproduces the data in normal way, thus recovering the error made in data-reading operation.

(Second Read-Retry Method)

The second read-retry method that can be performed in the present embodiment will be described, with reference to the timing chart of FIGS. 7A to 7C.

In the second read-retry method, the CPU 13 changes the PLL parameter to delay the start timing of the acquisition-mode period (AT) by a period 700, as illustrated in FIGS. 7A and 7B. Although its start timing is delayed, the period (AT) is just as long as in the case where data is read in normal way.

Since the acquisition-mode period (AT) remains unchanged in length, its expiration is delayed by a period 701 as depicted in FIGS. 7A and 7B. As a result, the frequency-jitter part 300A lies at the middle part of the acquisition-mode period (AT) as in the case illustrated in FIG. 6B. Hence, the period during which the frequency error exceeds the permissible value is shortened as seen from FIG. 7C. This enhances the possibility that the output data of the PLL circuit 105 regains the normal value until the period (AT) expires. Thus, the read-retry operation reproduces the data in normal way, recovering the error made in data-reading operation.

To delay the start of the acquisition-mode (AM) operation, the CPU 13 may delay the supply of the read-gate signal RG to the HDC 12. Further, the PLL control circuit 106 may have a delay circuit that receives the read-gate signal RG as input. In this case, the CPU 13 controls the delay circuit, thereby to delay the start of the acquisition-mode (AM) operation by any desired time.

If the frequency-jitter part 300A exists immediately before, for example, the sync byte region 301, the CPU 13 sets the PLL circuit 105 in the acquisition mode earlier than usual. The PLL circuit 105 can therefore operate in the tracking mode during the latter half of the period that corresponds to the PLL circuit 105 in which the frequency-jitter part 300A exists. In the tracking mode, the PLL circuit 105 slowly adjusts the frequency and phase of the read signal to those of the data output from the equalizer 103. Thus, the PLL frequency would not greatly change, and the read channel can reproduce the data in normal way.

(Third Read-Retry Method)

The third read-retry method that can be performed in the present embodiment will be described, with reference to the timing chart of FIGS. 8A to 8C.

In the third read-retry method, the timing of starting and terminating the acquisition-mode (AM) operation and the length of acquisition-mode period (AT) are the same as in the case where the data is read in normal way, as can be seen from FIGS. 8A and 8B. In the third read-retry method, the CPU 13 changes the PLL parameter to decrease the gain that the PLL circuit 105 obtains in the acquisition mode (AM).

In the third read-retry method, the PLL circuit 105 slowly adjusts the frequency and phase of the read signal to those of the data output from the equalizer 103. The frequency error due to the frequency-jitter part 300A therefore decreases relative to the frequncy of the read signal (see FIG. 8C). This renders it possible to reproduce the data in normal way, recovering the read error.

(Fourth Read-Retry Method)

The first to third read-retry methods, all described above, serve to reproduce the data in normaly way, in spite of the short-period fluctuation of frequency due to the frequency-jitter part 300A that lies in the PLL-sync data region 300.

Assume that the not only the data recorded in the PLL-sync data region 300, but also the data recorded in the user data region 302 change in terms of frequency. Then, frequency fluctuation lasts long, and none of the read-retry method described above can recover the read error. The fourth read-retry method according to the invention can recover the read error even if the frequency fluctuation lasts long, as will be explained with reference to FIGS. 9 and 10.

If the number of times (RN) the read-retry has been repeated does not exceed the number of times (MAX) (that is, if NO in Step S5), the CPU 13 refers to the parameter table 140 before performing the next read-retry. To be more precise, the CPU 13 reads retry parameters from the parameter table 140 (Step S6). The CPU 13 alters the PLL parameter of the PLL circuit 150 in accordance with the retry parameters read from the table 140 (Step S7), thereby causing the read channel to read the data again.

As shown in FIG. 10, the parameter table 140 contains a retry parameter which is the PLL parameter for the PLL circuit 105. The retry parameter defined by three values, i.e., the timing (T1, T2 or T3) of starting the acquisition-mode (AM) operation, the gain (Ga1, Ga2 or Ga3) for the acquisition-mode operatin, and the PLL gain (Gt1, Gt2 or Gt3) for the tracking-mode (TM) operation.

The CPU 13 alters an inary retry parameter to carry out an ordinary read-retry. Note that the ordinary retry parameter is used as a parameter that the read channel uses to reproduce the data from the disk 1. The ordinary retry parameter includes the degree of boosting at the LPF 101 and the position offset of the head 2.

In the present embodiment, the CPU 13 alters the ordinary retry parameter, performing the first ordinary read-retry to the 128th ordinary read-retry. The PLL parameter holds the intial values (T1, Ga1 and Gt1) while the the first to 128th ordinary read-retries are being perfomed.

To perform the 129th ordinary read-retry and the subsequent ordinary read-retries, the CPU 13 refers to the parameter table 140, causing the PLL circuit 106 to alter the PPL parameter of the PLL circuit 105 as shown in FIG. 10 (Step S7). Thus, the 129th ordinary read-retry and the subsequent ordinary read-retries are crried out.

The CPU 13 alters the PLL parameter by using the timing T2 of starting the acquisition-mode (AM) operation, which follows the timign T1, or the timing T3 that follows the timign T2. The CPU 13 alters the PLL parameter by using the gain Ga2 for the acquistion-mode (AM) operation, which is smaller than the initial value (Ga1), or the gain Ga3 that is smaller thant the gain Ga2. Further, the CPU 13 alters the PLL parameter by using the gain Gt2 for the tracking-mode (TM) operation, which is larger than the initial gain (Gt1), or the gain Gt3 that is larger than the gain Gt2.

More specifically, the CPU 13 alter the PLL parameter by using the timing T1 initially set, as timing of starting the acquisition-mode (AM) operation, while the 129th to 132nd read-retries are being carried out. Throughout the acquisition-mode (AM) operation, the CPU 13 alters the PLL parameter by using the gain Ga2 that is one step smaller than the initial gain Ga1. While the 137th to 140th read-retries are being performed, the CPU 13 alters the PLL parameter by using the timing T2 that is one step later than the timing T1 initially set, as the timing of starting the acquisition-mode (AM) operation, and by using the initial gain Ga1 as PLL gain for the acquisition-mode (AM) operation. While the 193rd read-entry and the subsequent read-entires are being performed, the CPU 13 alter the PLL parameter by using the gains Gt2 or Gt3 that is larger the the initial gain Gt1, as PLL gain for the tracking-mode (TM) operation.

In this read-retry method, retries are performed out after the ordinary read-retries (i.e., the first to 128th read-entries) have been carried out. It is therefore possible to recover the read error that may result in a relaitvely long-term frequency fluctuation. Particularly, the PLL gain for the traking-mode (TM) operation can be set at a valve greater than the PLL gain (Gt1) initially set. Thus, the PLL circuit 105 can fast adjust the frequency and phase of the read signal to those of the data output from the equalizer 103 in the tracking-mode operation. As a result, the PLL-frequency error is minimized, enhancing the probability of read-retries that can recover the read error.

In this read-retry method, the main read-retry accompanying with the alteration of the PLL paramter is repeated after the ordinary read-retries have been carried out. The method may not be desirable if a read errror is frequently made at the frequency-fluctuating part (frequency-jitter part 300A) of any sector provided on the disk 1. In this case, the main read-retries should be repeated after the ordinary read-retires. Consequently, the main read-retry must be repeated more times than otherwise. This lowers the efficiency of reading data from the disk 1.

In view of this it is desired that the main read-retry, in which the PLL parameter is altered, be performed prior to the ordinary read-entries.

(Fifth Read-Retry Method)

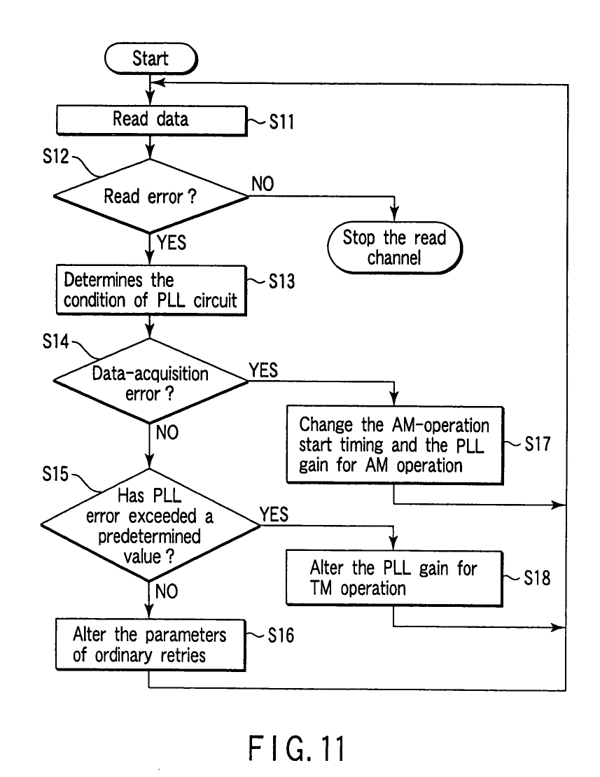

The fifth read-retry method that can be performed in the present embodiment will be described, with reference to the flowchart of FIG. 11.

In the fifth read-retry method, the CPU 13 determines which should be performed first, the ordinary read-retry or the main read-entry.

When data is reproduced in normal way, the CPU 13 determines this (if NO in Step S12) and stops the read channel. If the CPU 13 determines that the data has not been reproduced in normal way (if YES in Step S12), the CPU 13 determines the operating condition of the PLL circuit 105 via the PLL control circuit 106 before starting the read-retry and discriminates the retry parameter (Step S13).

More precisely, the CPU 13 acquires the data about the PLL error which has been made in the PLL circuit 105 during the acquisition-mode (AM) operation and which includes a frequency error and a phase error. From this data the CPU 13 determines whether a data-acquisition error has occurred (Step S14). If YES in Step S14, the CPU 13 changes the timing of starting the acquisition-mode (AM) operation and the PL gain for the acquisition-mode (AM) operation, thereby performing a read-retry (Step S17).

In the present embodiment, the PLL control circuit 106 detects the operating condition of the PLL circuit 105, holds the data representing the operating condition and supplies the data to the CPU 13.

The data contains two data items. The first data item represents the phase error or frequency error made in the acquisition-mode operation. The second data item represents the phase error or frequency error made in the tracking-mode operation.

The CPU 13 acquires the data about the PLL error (i.e., a frequency error and a phase error) made in the PLL circuit 105 during the tracking-mode operation. The CPU 13 determines whether the PLL error exceed a predetermined value (Step S15). If YES in Step S15, the CPU 13 alters the PLL gain for the tracking-mode operation, thereby performing a read-retry (Step S18).

If NO in Step S15, that is, if the PLL error does not exceed a predetermined value, the CPU 13 carries out an ordinary read-retry (Step S16). In the ordinary read-retry, the CPU 13 alters parameters other than the PLL parameter.

In the fifth read-retry method, the CPU 13 determines the cause of the read error before it performs a read-retry. On the basis of the cause of the read error the CPU 13 can select and perform a read-retry that is most likely to recover the read error. That is, the CPU 13 carries out an ordinary read-entry first if the read error has not resulted from any PLL-related cause of error (e.g., frequency-jitter part 300A). If it can be inferred that the read error has resulted from a PLL-related cause, the CPU 13 performs a main read-entry first, in order to alter the PLL parameter. Thus, the possibility that the read-retry for recovering read errors is effected first increases. This can shorten the time required to recover the read error by performing a successful read-retry.

### MODIFICATION OF THE EMBODIMENT

The read-retry method employed in a modification of the embodiment will be described below.

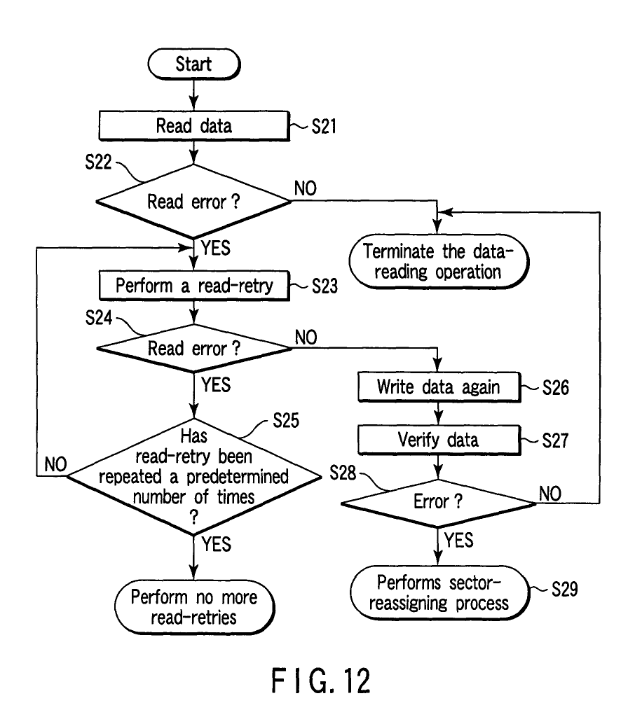

A frequency-fluctuating part (e.g., frequency-jitter part 300A) does not always lie at a position where projections protrude from the disk 1. In a frequency-fluctuating part lying at a position where no projections protrude from the disk 1, data can be recorded in normal way if written. The modification of the embodiment is based on this fact. How read-retries are carried out in the modification will be described, with reference to the flowchart of FIG. 12.

First, the head 2 reads data from the disk 1 (Step S21). The CPU 13 determines whether a read error has been made (Step S22). If NO, the data-reading operation is terminated. If YES, that is, if a read error has been made, the CPU 13 performs a read-retry to recover the read error (Step S23).

Next, the CPU 13 determines whether the read error still exists (Step S24). If YES, the CPU 13 repeats the read-retry and determines whether the read-retry has been repeated a predetermined number of times (Step S25). If NO in Step S25, the operation returns to Step S23. In this case, Steps S23, S24 and S25 are repeated until the read-retry is repeated the predetermined number of times. If YES in Step S25, no more read-retries are carried out.

If NO in Step S24, that is, if the read error no longer exists (or the read error has been recovered), the CPU 13 writes the data again in the data sector from which the data has been read (Step S26). Further, the CPU 13 carries out a verification process to read and verify the data that has been rewritten in the data sector (Step S27). The CPU 13 then determines whether an error is made in Step S27 (Step S28). If YES, the CPU 13 performs a sector-reassigning process, replacing the data sector with another data sector (Step S29).

As described above, the data is rewritten in the data sector if the read-retry successfully recovers the read error in the read-retry method. The frequency-fluctuating part (e.g., frequency-jitter part 300A) can thus be eliminated. This prevents read errors from occurring when the data is read from this data sector. Hence, the necessity of performing read-retries decreases.

The CPU 13 performs the sector-reassigning process only if read errors can hardly be recovered at data sectors. This ultimately reduces the number of data sectors that need to be used in place of the data sectors where the read errors can hardly be recovered. Note that the read-retry includes the data-reading step performed in the above-mentioned verification process.

As has been described in detail, the embodiment of the invention and the modification of the embodiment can provide a disk drive that has the function of recovering the read errors made at the frequency-jitter parts of recorded data when the head when in the data contacts the disk.

The invention is particularly effective when applied to a contact-type disk drive in which PLL-sync data is likely to have frequency-jitter parts when the head contacts the disk to write data in the data regions. The invention is effective when applied to a disk drive of head-flying type, too. This is because the head may contact the disk in some cases even in the head-flying type disk drive. The read-retry method according to the invention can efficiently recover read errors resulting from the frequency-jitter parts of data, in both a contact-type disk drive and a head-flying type disk drive.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A disk drive comprising:
a head which reads data signals from any data region provided on a disk-shaped recording medium;
a phase-locked loop unit which generates a read clock signal;
a read channel which reproduces data from any data signal that the head has read from the disk-shaped recording medium, in synchronism with the read clock signal generated by the phase-locked loop unit; and
a controller which alters a PLL parameter of the phase-locked loop unit when the data recorded by the read channel contains an error, said PLL parameter being related to a frequency-jitter part existing, due to the error, in PLL sync data recorded in the data region, and which performs a read-retry in accordance with the PLL parameter thus altered, to cause the read channel to read the data again.

2. The disk drive according to claim 1, wherein the controller alters, as PLL parameter, any one of a plurality of operating parameters of the Phase-locked loop unit, including a timing for acquisition mode, a gain for the acquisition mode and a gain for tracking mode.

3. The disk drive according to claim 1, wherein the controller alters a timing for acquisition mode and a gain for the acquisition mode, selected from a plurality of operating parameters of the Phase-locked loop unit, and alters a combination of the parameters, as PLL parameter, to performs the read-retry.

4. The disk drive according to claim 1, wherein the controller alters the PLL parameter of the Phase-locked loop unit to set a gain for acquisition mode at a value lower than a value usually applied.

5. The disk drive according to claim 1, wherein the controller has means of altering, as PLL parameter, any one of a plurality of operating parameters of the phase-locked loop unit, including a timing for acquisition mode, a gain for the acquisition mode and a gain for tracking mode; alters a combination of the timing and the gain, both for acquisition mode, as PLL parameter, to performs the. read-retry; and changes the timing and gain for acquisition mode, back to normal values and alters the gain for tracking mode to perform the read retry, when the read retry is unable to recover the error.

6. The disk drive according to claim 1, wherein the controller has means of altering any one of a plurality of operating parameters of the phase-locked loop unit, including a timing for acquisition mode, a gain for the acquisition mode and a gain for tracking mode; alters the gain for tracking mode, as PLL parameter, to perform the read retry; and changes the gain for tracking mode, back to normal values, when the read retry is unable to recover the error, and alters a combination of the timing and the gain, both for acquisition mode, to performs the read-retry.

7. The disk drive according to claim 1, wherein the controller alters the PLL parameter of the Phase-locked loop unit to set a gain for acquisition mode at a value lower than a value usually applied, and a gain for tracking mode at a value higher than a value usually applied.

8. The disk drive according to claim 1, wherein the controller alters an operating parameter of the read channel, other than the PLL parameter, to perform an ordinary read-retry, then alter any one of a plurality of a plurality of operating parameters of the phase-locked loop unit to perform the read-retry when the ordinary read retry is unable to recover the error.

9. The disk drive according to claim 1, wherein the controller alters any one of the PLL parameters to perform the read-retry at first step, and alters an operating parameter of the read channel, other than the PLL parameter, to perform the ordinary read-retry again when the first step read-retry is unable to recover the error.

10. A disk drive comprising:
a head which reads data signals from any data region provided on a disk-shaped recording medium;
a phase-locked loop unit which generates a read clock signal and which has a plurality of PLL parameters;
a read channel which reproduces data from any data signal that the head has read, in synchronism with the read clock signal generated by the phase-locked loop unit; and
a PLL control unit which alters any one of the PLL parameters of the Phase-locked loop unit, including a timing for acquisition mode, a gain for the acquisition mode and a gain for tracking mode;
a detecting unit which detects an operating condition of the phase-locked loop unit; and
a controller which alters any one of the PLL parameters when the detecting unit detects that the phase-locked loop unit is operating in an abnormal condition due to an error in the data reproduced by the read channel, and which cause the reach channel to read the data again in accordance with the PLL parameter altered.

11. The disk drive according to claim 10, wherein the controller causes the read channel to perform an ordinary read-retry in accordance with an operation parameter of the read channel, other than the plurality of PLL parameters, when the phase-locked loop unit operates in a normal condition.

12. The disk drive according to claim 10, wherein the detecting unit acquires, as data representing the operating condition of the phase-locked loop unit, information about a phase error or a frequency error made in acquisition mode or in tracking mode.

13. The disk drive according to claim 12, wherein the controller causes the read channel to perform a read-retry in accordance with information obtained from the detecting unit when the phase error or frequency error made in the acquisition mode or in the tracking mode exceeds a permissible value.

14. A disk drive comprising:
a head which reads data signals from any data region provided on a disk-shaped recording medium;
a read channel which reproduces data from any data signal that the head has read; and
a controller which causes the read channel to perform a read-retry when an error occurs in data reproduced by the read channel and cause the head to write, in the data region, the same data that the head has read, when the error is recovered by the read-retry.

15. The disk drive according to claim 14, further comprising a verification unit which reads and verifies data after the head has written the data under control of the controller.

16. The disk drive according to claim 15, further comprising a unit which causes the head to write the data in a data region other than the data region from which the read channel has read the data, when the verification unit detects an error in the data.

17. A read channel for reproducing data from a disk medium by using a head in a disk drive, comprising:
a phase-locked loop unit which has a plurality of PLL parameters and which generates a read clock signal required in reproducing data from the disk medium;
a PLL control unit which sets or alter any one of the PLL parameters including a timing for acquisition mode, a gain for the acquisition mode and a gain for tracking mode;
a unit which transmits information about an operating condition of the phase-locked loop unit, to an external device, said information representing a phase error or frequency error made in the acquisition mode or in the tracking mode.

18. A method of reproducing data from a disk medium by using a head in synchronism with a read clock signal generated by a phase-locked loop unit in a disk drive, the method comprising:
performing an ordinary read-retry when a read error is made while the head is reproducing the data from the disk medium; and
performing a read-retry when the ordinary read-retry fails to recover the read error, by altering any one of PLL parameters of the phase-locked loop unit, including a timing for acquisition mode, a gain for the acquisition mode and a gain for tracking mode.

19. The method according to claim 18, further comprising:
detecting an operating condition of the phase-locked loop unit when a read error is made while the head is reproducing the data from the disk medium; and
performing a read-retry by altering any one of the PLL parameters, when the operating condition of the phase-locked loop unit exceeds a permissible value.

20. The method according to claim 18, further comprising:
writing data in a data region of the disk medium when the read-retry recovers the error, said data being the same data the head has read from the data region.
